(19) United States
(12) Patent Application Publication
(10) Pub. No.: US 2026/0094739 A1
(43) Pub. Date: Apr. 2, 2026

(54) COOLED LINE

(71) Applicant: LEONI KABEL GMBH, Roth (DE)

(72) Inventors: SEBASTIAN GOSS, Roth (DE); JOACHIM NIEDERWIESER, Roth (DE); CHRISTIAN ROSSMANN, Abenberg (DE)

(21) Appl. No.: 19/325,607

(22) Filed: Sep. 11, 2025

(30) Foreign Application Priority Data
Oct. 1, 2024 (EP) 24203947.7

(51) Int. Cl. H01B 7/42; H01B 9/00

(52) U.S. Cl. CPC H01B 7/423; H01B 9/006

(57) ABSTRACT

The invention relates to a high-voltage line or a line for a charging cable and to a charging cable for electric vehicles with such lines. The line includes a cooling hose in which a cooling medium can be carried. Electrical conductors are arranged around the cooling hose in the circumferential direction of the cooling hose and each have a cross-sectional shape that deviates from a round shape.

### CROSS-REFERENCE TO RELATED APPLICATIONS

This application claims priority to European Patent Application 24203947.7 filed on Oct. 1, 2024, the contents of which are incorporated by reference herein in their entirety.

### TECHNICAL FIELD

The invention relates to a line, in particular a high-voltage line or a line for a charging cable. Furthermore, the invention relates to a charging cable for electric vehicles with such lines.

### BACKGROUND

In conventional cooled lines, round, in particular circular, electrical conductors are arranged around a cooling hose, put more precisely, electrical conductors with a round, in particular circular, cross section. Due to this, the thermal coupling between the electrical conductors and the cooling hose is not optimal. To improve the thermal coupling, a paste is sometimes used, which connects the electrical conductors better to the cooling hose. This paste also brings disadvantages with it, however, in particular in the assembly of the electrical conductors, for example by crimping, welding etc., as this is to be regarded as an impurity.

A requirement exists, therefore, for improved cooled lines, in particular cooled lines with a better thermal coupling between the electrical conductors and the cooling hose.

### SUMMARY

According to a first aspect of the invention, a line is provided. The line has a cooling hose. A cooling medium can be carried in the cooling hose. The line has a number of electrical conductors. The several electrical conductors are arranged around the cooling hose in the circumferential direction of the cooling hose. The several electrical conductors have a cross-sectional shape that differs from a round, in particular circular, shape.

Due to the arrangement of the electrical conductors around the cooling hose, the several electrical conductors are connected in a heat-conducting manner to the cooling hose such that the several electrical conductors can be cooled by the cooling medium. A heat-conducting connection can be understood to mean a direct/immediate or indirect heat-conducting connection between the electrical conductors and cooling hose, in particular a direct/immediate or an indirect heat-conducting connection between the electrical conductors and an exterior/outer surface of the cooling hose. By way of the heat-conducting connection, a heat-conducting exchange can be created between the cooling hose (put more precisely, the cooling medium that can be carried in the cooling hose) and the several electrical conductors. The line can also be described as a cooled line.

The several electrical conductors can be arranged around the cooling hose in the circumferential direction of the cooling hose. Due to the arrangement of the electrical conductors around the cooling hose, the electrical conductors are cooled efficiently. The line can therefore be operated with a high power or with high voltages without strong heating occurring. The electrical conductors have a larger surface than a corresponding single conductor. Due to this, the cooling of the electrical conductors is efficient. The cooling medium can be liquid or gaseous, for example. On account of the non-round, in particular non-circular, cross-sectional shape of the electrical conductors, moreover, a contact surface of the electrical conductors on the cooling hose is increased compared with a round, in particular circular, cross-sectional shape. The cooling efficiency is improved further thereby. The current carrying capacity of the electrical conductors is thereby increased still further.

The line can be formed as a high-voltage line for a vehicle. The line can be provided or used, for example, as a high-voltage line in an electrical system of a vehicle. The line can be formed as a line for a charging cable. The charging cable can be formed as a charging cable for electric vehicles.

The several electrical conductors can have a number of electrical conductors not insulated from one another or be formed as a number of electrical conductors not insulated from one another. The several electrical conductors not insulated from one another can be described in brief also as several uninsulated electrical conductors.

With regard to the several electrical conductors not insulated from one another, “not insulated” can be understood to mean that these are not electrically insulated. For example, no insulation is arranged respectively around the electrical conductors. On account of the heat-conducting connection, heat arising through the electrical conductors can be dissipated via the cooling medium that can be or is carried in the cooling hose, i.e. the electrical conductors can be cooled directly, for example, via the heat-conducting connection by means of the cooling medium that can be or is carried in the cooling hose, without insulation around the electrical conductors impairing the heat transmission and/or heat dissipation.

The several electrical conductors can be in direct contact with the cooling hose. In this way, a heat-conducting connection can be improved. For example, the electrical conductors can be directly/immediately in contact with the exterior/outer surface of the cooling hose. This leads to particularly efficient cooling of the electrical conductors. The several electrical conductors can be in indirect contact with the cooling medium. For example, the several electrical conductors can be separated from the cooling medium by the cooling hose.

The indirect contact between the electrical conductors and the cooling medium leads to the electrical conductors, e.g. the copper of such a conductor, not being directly enclosed by the cooling liquid. In this way, problems or risks on account of direct contact between cooling medium and electrical conductors are avoided. Furthermore, the cooling medium must not necessarily be insulating and attention does not necessarily have to be paid to ensuring that no conductive particles get into the cooling circuit through heat exchangers etc., for example. Moreover, the cooling medium can be optimised in respect of its environmental compatibility.

The several electrical conductors can be arranged around the cooling hose stranded with one another, braided or unstranded. In the case of a braided or stranded arrangement around the cooling hose, the electrical conductors can be cooled still more efficiently. In the case of an unstranded arrangement of the electrical conductors around the cooling hose, the construction can be configured particularly simply.

The several electrical conductors can have respectively a stranded conductor (or litz wire for short), for example a flexible litz wire, or be formed as a stranded conductor, for example a flexible litz wire. The litz wire can have several single conductors or single wires or consist of several single conductors or single wires. The several electrical conductors can each have a solid conductor or be formed as a solid conductor.

The respective stranded conductor of the several electrical conductors can have a plurality of single wires or be formed by a plurality of single wires in each case. The single wires can be arranged irregularly or unevenly relative to one another. Stranding of the single wires or wire bundles can exist at least in sections in the respective stranded conductor.

The electrical conductors can be formed semi-concentrically, for example, or as a bunched conductor or as an unstranded bundle. In comparison with this, (circular) round electrical conductors can be formed as concentric litz wires or have concentric litz wires.

The single wires can be bunched with one another. The respective stranded conductor of the several electrical conductors can have a bunched conductor or be formed as a bunched conductor in each case. A bunched conductor can also be described as a bundled strand. In a bunched conductor/bundled strand, there is no fixed order of the single wires or wire bundles inside the litz wire, for example. For example, the position of the wires relative to one another can change constantly over the entire running length of the litz wire.

According to one example, the position of the single wires in the stranded conductor, for example in the bunched conductor, can be initially at least virtually the same over the length, as these are twisted together and run in in a defined manner before a bunching point, for example. If the stranded conductors are stranded around the cooling hose, however, a structure of the stranded conductors that is not round or concentric, for example, can lead to the conductors being pressed into a shape similar to a pie wedge due to a pressing force in the stranding process of the stranded conductors around the cooling hose and the position of the single wires then being reoriented to one another. Thus one or more of the single wires can press at least in sections into the cooling hose.

For example, due to appropriate adjustment or adaptation of a stranding force in the stranding process, a slight or minimal, for example, pressing-in of the single wires into the cooling hose can be targetedly adapted or caused or achieved. Due to the slight pressing-in, the contact area of single wire/single wires and cooling hose is increased accordingly, whereby better heat transmission is facilitated in turn.

For example, the single wires of a bunched conductor can initially run at least virtually parallel. By stranding of the several bunched conductors around the cooling hose, a slight stranding can occur in the bunched conductors themselves, which is reflected in a small lay length. If the stranded conductors formed for example as bunched conductors are stranded around the cooling hose running centrally, these can open slightly and form a cross-sectional shape deviating from a (circular) round cross-sectional shape.

The cross-sectional shape of at least one of the several electrical conductors can be at least virtually trapezoidal in each case. In particular, the cross-sectional shape of at least one of the several electrical conductors can correspond at least virtually to a shape of an isosceles trapezium. The cross-sectional shape can also be described as similar to a pie wedge, wherein the tip of the pie wedge can be cut off, for example. An overall composite of the electrical conductors with the cooling hose can thus form a composite similar to a pie. Due to the at least virtually trapezoidal cross-sectional shape, a larger section of the electrical conductors can rest on the cooling hose or have a direct heat-conducting connection, for example, to the cooling hose than in the case of electrical conductors with a round, for example circular, cross-sectional shape. Expressed differently, a contact surface of the electrical conductors on the cooling hose is increased compared with a (circular) round configuration of the conductors. In this way, the heat exchange between electrical conductors and the cooling medium is optimised, whereby cooling efficiency is improved. By improving the cooling efficiency, higher currents can be conducted through the line. Expressed differently, the current carrying capacity of the line can be increased.

In the composite with the cooling hose, the electrical conductors can also be described as conductor packets or conductor units.

The several electrical conductors can each have an inner surface pointing towards the cooling hose. The inner surface of at least one of the several electrical conductors can be formed at least virtually even in cross section, at least in sections, for example completely. For example, the respective inner surface of the several electrical conductors can be formed at least virtually even in cross section, at least in sections, for example completely. Alternatively, the inner surface of at least one of the several electrical conductors can be formed at least virtually concave in cross section, at least in sections, for example completely. For example, the respective inner surface of the several electric conductors can be formed at least virtually concave in cross section, at least in sections, for example completely. According to one example, the inner surface of at least one of the several electrical conductors can be formed at least virtually concave in cross section and the inner surface of at least one of the several electrical conductors can be formed at least virtually even in cross section. Alternatively, the inner surface of each of the several electrical conductors can be formed at least virtually concave in cross section. According to one example, a section of the inner surface of at least one of the several electrical conductors can be formed at least virtually concave in cross section and another section of the inner surface of the at least one of the several electrical conductors can be formed at least virtually even in cross section. Consequently, a combination of at least one even section and at least one concave section is possible on the inner surface of the several electrical conductors. Herein, in accordance with the usual understanding, concave is to be understood as curved inwards.

Due to the at least virtually even and/or concave formation in cross section, a larger section of the electrical conductors can rest on the cooling hose or have a direct heat-conducting connection, for example, to the cooling hose than with (circular) round electrical conductors with a convex inner surface. Expressed differently, a contact surface of the electrical conductors on the cooling hose is increased compared with a (circular) round configuration of the conductors. For example, due to the even and/or concave inner surface in cross section, the electrical conductors can be placed more homogeneously on the cooling hose than (circular) round electrical conductors. In particular, due to the even and/or concave formation of the inner surface in cross section, a better thermal connection of the electrical conductors to the cooling hose is enabled. The cooling efficiency is improved in this way. By improving the cooling efficiency, higher currents can be conducted through the line. Expressed differently, the current carrying capacity of the line can be increased. With an at least virtually concave configuration of the inner surface in cross section, the electrical conductors can rest particularly homogeneously on the cooling hose. The cooling efficiency is therefore increased still further compared with an at least virtually even configuration of the inner surface in cross section.

For example, a line according to the first aspect (with not (circular) round, in particular at least virtually trapezoidal, electrical conductors) with a line cross section of 50 mm² can have approximately the same current carrying capacity as a line with (circular) round conductors or litz wires with a line cross section of 70 mm².

The several electrical conductors can each have an outer surface pointing away from the cooling hose. The outer surface of at least one of the several electrical conductors can be formed at least virtually even in cross section, at least in sections. The outer surface of at least one of the several electrical conductors can be formed at least virtually convex in cross section. Herein, in accordance with the usual understanding, convex is to be understood as curving outwards.

The cooling hose can generally be a body extending in the longitudinal direction of the charging cable. The body can have a cavity in which a cooling medium (can also be described as a coolant) can circulate. The cooling hose is not limited to a certain cross section. The cooling hose can have a round, angular or oval cross section, for example. The cooling hose can assume the shape of a hollow cylinder, but is not limited to such a shape. The cooling hose extends along the full length of the line, for example. The cooling hose can be formed flexibly, i.e. in particular not rigidly. The cooling hose can be elastically bendable or deformable, for example.

The cooling hose can be formed at least virtually tight or impenetrable for the cooling medium. The cooling hose can be completely closed in the longitudinal direction and circumferential direction for this, for example. For example, the cooling hose can have a sheath, so that the cooling hose forms a cavity in its interior for receiving the cooling medium. The sheath can be formed at least virtually tight or impenetrable for the cooling medium. In this way, the cooling medium can circulate in the cavity but at least virtually not penetrate the sheath. In the line, the electrical conductors arranged around the cooling hose, for example around the sheath of the cooling hose, do not thereby come into contact with the cooling medium when the cooling hose, in particular the sheath of the cooling hose, is in an undamaged state. Any cooling medium can therefore be used in principle. In the case of an undamaged cooling hose, no contact therefore occurs between cooling medium and electrical conductors in the line and therefore no problems arise with contact between cooling medium and the electrical conductors. Expressed differently, the sheath of the cooling hose can enclose the cooling medium in the line. The electrical conductors can be located outside of the sheath, for example on the exterior/outer surface of the sheath.

The several electrical conductors can be formed as copper conductors or as aluminium conductors. In particular, the single wires of the electrical conductors can each be formed as copper wires or as aluminium wires or as enamel-insulated copper wires or as enamel-insulated aluminium wires. The copper wires, for example, can thus themselves be enamel-insulated, but the electrical conductors formed by the enamel-insulated copper wires themselves have no insulation of their own, for example. On account of the high electrical conductivity of copper, the line can conduct high currents.

The line can further have insulation. The insulation can enclose the cooling hose and the several electrical conductors. For example, the insulation can enclose the several electrical conductors and the cooling hose around which the several electrical conductors are arranged. The insulation can enclose the several electrical conductors directly. The insulation can be in direct/immediate contact with the electrical conductors. The insulation can be directly/immediately in contact with the cooling hose, for example the exterior/outer surface of the cooling hose.

According to a second aspect, a charging cable is provided. The charging cable is formed as a charging cable for electric vehicles, for example. The charging cable can have at least a first line according to the first aspect and at least a second line according to the first aspect. The charging cable accordingly has at least a first cooling hose (i.e. a cooling hose of the at least one first line according to the first aspect) and at least a second cooling hose (i.e. a cooling hose of the at least one second line according to the first aspect).

In this case, several electrical conductors are accordingly arranged around the first cooling hose in the circumferential direction of the first cooling hose. Several electrical conductors are correspondingly arranged around the second cooling hose in the circumferential direction of the second cooling hose.

The cooling hose of the at least one first line can be formed as a forward flow for the cooling medium. The cooling hose of the at least one second line can be formed as a return flow for the cooling medium. The cooling medium can thereby circulate completely in the charging cable. The forward flow can also be described as a feed line. The return flow can also be described as a return line. For example, the forward flow can constitute a feed line to plug cooling and the return flow can constitute a return line for cooling fluid from the plug cooling. The feed line can be understood to mean a conduit or hose which leads away from a location with high fluid pressure. The return line can be understood to mean a conduit or hose which leads to a location with low fluid pressure. The cooling fluid can be transported out by the forward flow and back by the return flow.

Alternatively, the cooling hose of the at least one first line can be formed as a return flow and the cooling hose of the at least one second line can be formed as a forward flow for the cooling medium.

Alternatively, the cooling fluid can be transported out or back by both lines and e.g. transported back or out by other hoses. Furthermore, the cooling medium can be pumped e.g. as a cooling fluid through the lines and exit at the end.

For example, the cooling hose of the at least one first line and the cooling hose of the at least one second line, for example, can be formed as a forward flow for the cooling medium. In this case, an additional return flow for the cooling medium, for example, can be arranged in the charging cable. Alternatively, the cooling hose of the at least one first line and the cooling hose of the at least one second line, for example, can be formed as a return flow for the cooling medium. In this case, an additional forward flow for the cooling medium, for example, can be arranged in the charging cable.

The several electrical conductors can form a direct current core. The direct current core serves to transmit direct current in the charging cable. For example, the direct current core can be one of the (two) direct current cores of a charging cable required to transmit direct current. The several electrical conductors of the at least one first line can form a common positive direct current core. Expressed differently, the several electrical conductors around the first cooling hose can form a positive direct current core. The several electrical conductors of the at least one second line can form a common negative direct current core. Expressed differently, the several electrical conductors around the second cooling hose can form a negative direct current core. Efficient direct current charging of electric vehicles can thus take place by means of the charging cable.

For example, currents of a hundred amperes (A) or several hundred amperes, for example of up to harge. 1500 A or even up to 3000 A (with two cores in each direction, for example), can be transmitted using the charging cable without any notable heating of the lines and/or of the charging cable occurring in the case of intact cooling. This means that despite relatively small/minimal cross sections of the lines, a high power can be transmitted from the charging station into the vehicle (and thus to the battery).

The charging cable can have an outer jacket. The outer jacket protects the charging cable and can therefore also be described as a protective jacket. The common outer jacket holds the lines together and protects them against abrasion and environmental influences, for example. The outer jacket can also be thermally insulating. The thermal insulation is advantageous in particular if the cooling medium is formed as a cooling fluid. The thermal insulation prevents freezing of the cooling fluid, for example.

Thehargeng cable can have one or more conductors or one or more cores for charging with alternating current (alternating current conductors for short). By means of the one or more conductors for alternating current, the charging cable can be used for alternating current charging of an electric vehicle. For example, the charging cable can be a combination cable with which both direct current and alternating current charging is enabled. Purely by way of example, let a possible configuration with three conductors/cores (conductor, neutral conductor, earth), five conductors/cores (three conductors, neutral conductor, earth) or seven conductors/cores (three conductors, neutral conductor, earth and two conductors for communication between an energy source, e.g. a charging station, and an energy sink, e.g. a battery of an electric vehicle or an electric vehicle) be cited here. In addition or alternatively, the charging cable can have data lines. The data lines can be formed for data transmission between an energy source/power source, e.g. a charging station, and an energy sink/current sink, e.g. a vehicle battery/a vehicle. The energy source/power source and the energy sink/current sink can communicate with one another via the data lines.

The hargeng cable can form a common charging system with the evaluation unit according to a third aspect of the invention. Expressed differently, a charging system according to a third aspect of the invention can have the charging cable and the evaluation unit. Alternatively or additionally to the evaluation unit, the charging system can have the charging cable, a terminal connection and a plug. The terminal connection can have a feed for the cooling medium, which can introduce the cooling medium into at least one of the lines, put more precisely into the cooling hose of at least one of the lines, and can receive it from another of the lines, put more precisely from the cooling hose of another of the lines. The plug is formed to be connected to the vehicle. In addition to the electrical contacts for electrical connection of the electrical conductors present to lines of the vehicle, the plug can have a fluid return path, which can receive the cooling medium from the cooling hose of a line and carry it to the cooling hose of the other line.

Furthermore, according to a fourth aspect, a charging station with the charging cable according to the second aspect or with a charging system according to the third aspect can be provided.

Furthermore, according to a fifth aspect, an electrical system for a vehicle with a number of lines according to the first aspect can be provided. The lines can be formed in particular as high-voltage lines, e.g. as single-core high-voltage lines. The high-voltage lines can be formed as shielded or unshielded lines. A combination of shielded and unshielded lines is also conceivable.

Even if some of the aspects described above were described with regard to the line according to the first aspect, these aspects can also be realised in a corresponding manner in the charging cable according to the second aspect, the charging system according to the third aspect, the charging station according to the fourth aspect and/or the electrical system according to the fifth aspect and vice-versa.

### BRIEF DESCRIPTION OF THE DRAWINGS

The present invention is to be explained further on the basis of figures. These figures show schematically:

FIG. 1 a depiction of a cross section of a cooled line;

FIG. 2 a depiction of a cross section of an exemplary embodiment of a cooled line; and

FIG. 3 a depiction of a cross section of an exemplary embodiment of a charging cable with two lines according to FIG. 2.

In the following, without being restricted hereto, specific details are set out to provide a complete understanding of the present invention. It is clear to an expert, however, that the present invention can be used in other exemplary embodiments that can differ from the details set out below. The figures serve further purely for purposes of clarifying exemplary embodiments. They are not true to scale and are only intended to reflect the general concept of the invention by way of example. For example, features that are contained in the figures are by no means to be considered as a necessary constituent.

### DETAILED DESCRIPTION

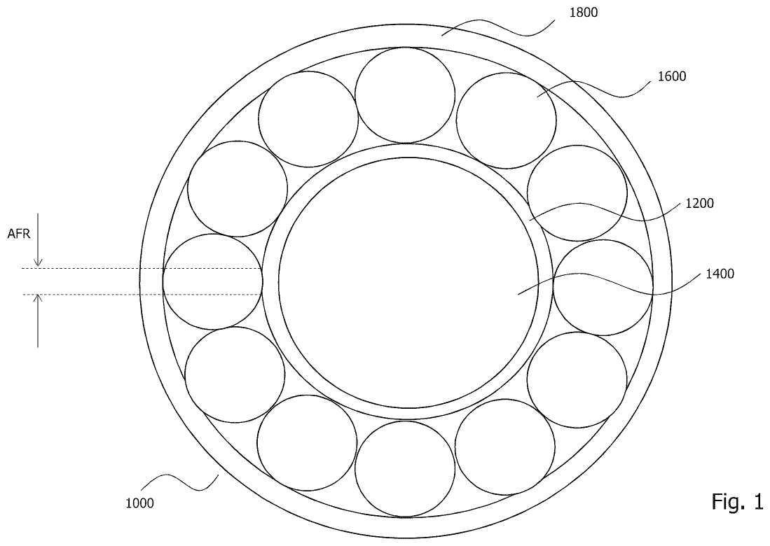

FIG. 1 shows a cross section of a line 1000. The line 1000 has a cooling hose 1200 and several electrical conductors 1600 not insulated from one another. A cooling medium 1400 can be carried in the cooling hose 1200. Put more precisely, the cooling hose 1200 from FIG. 1 has by way of example a sheath, an outer jacket or an outer sleeve and an at least largely hollow inner space. The cooling medium 1400 can be carried in the inner space. The outer jacket can also be described as an insulating sleeve and is chiefly also described as such below.

The several electrical conductors 1600 are arranged around the cooling hose 1200 in the circumferential direction of the cooling hose 1200. In the example from FIG. 1, the electrical conductors 1600 are respectively in direct contact with the exterior (the outer surface) of the cooling hose, for example the exterior of the insulating sleeve of the cooling hose 1200. The several electrical conductors 1600 each have a circular shape in their cross section. Other round cross-sectional shapes are alternatively conceivable.

The electrical conductors 1600 can each have single wires or stranded conductors or braids or be formed from these. The round, in particular circular, shape can be achieved, for example, by a concentrically constructed litz wire. In concentrically constructed litz wires, each single wire has a defined position in the litz wire. One or more wire layers are arranged concentrically over a central wire. In concentrically constructed litz wires, the single wires assume a precisely defined position around the inner core wire. An absolutely regular structure is achieved thereby.

The electrical conductors 1600 each rest with a contact section AFR on the cooling hose 1200.

The cooling hose 1200 is at least virtually tight for the cooling medium 1400. This means that in a normal, undamaged state of the cooling hose 1200, the cooling medium cannot normally penetrate outwards from the interior (inner space) of the cooling hose 1200. The insulating sleeve of the cooling hose 1200 is at least virtually tight/impenetrable for the cooling medium in an undamaged state. The electrical conductors 1600 do not therefore come into contact with the cooling medium 1400 in an undamaged cooling hose 1200. The electrical conductors 1600, put more precisely the totality of the electrical conductors 1600 (not each of the conductors themselves) and the cooling hose 1200 are enclosed by insulation 1800. The insulation 1800 serves among other things for electrical insulation of the electrical conductors 1600.

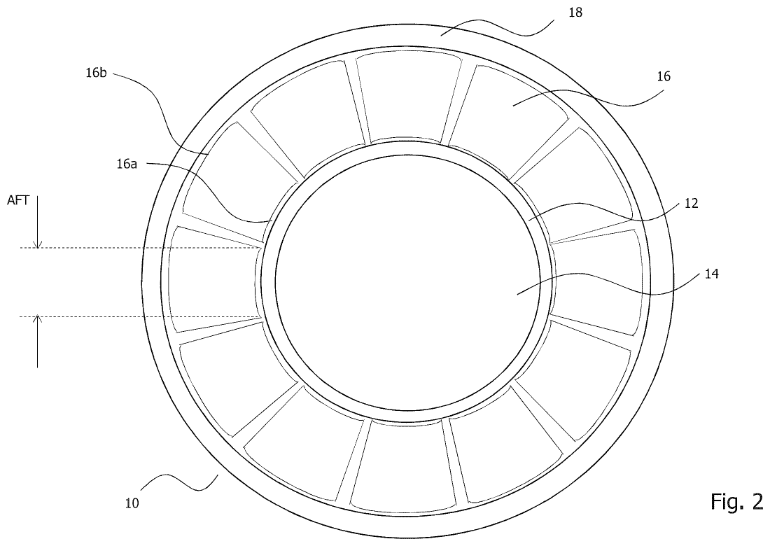

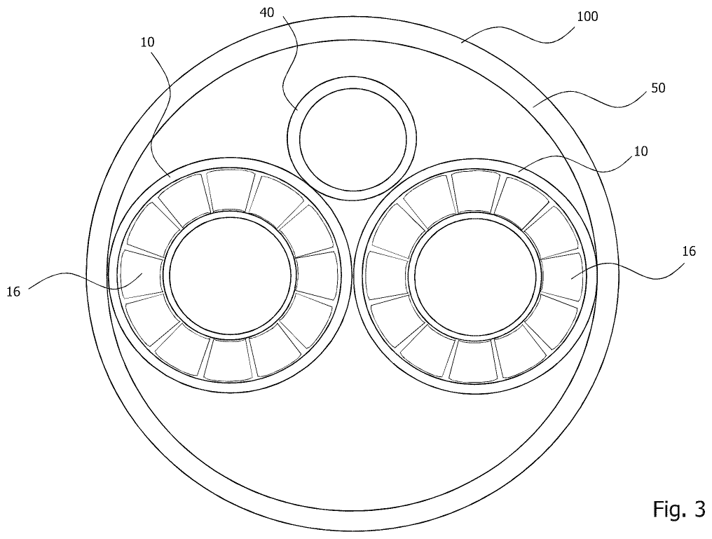

FIG. 2 shows a cross section of an exemplary embodiment of a line 10 according to an exemplary embodiment. In one example, the line 10 can be formed as a single-core high-voltage line for a vehicle, for example. In another example, the line 10 can be formed as a line for a charging cable for electric vehicles, for example (see FIG. 3).

The line 10 has a cooling hose 12. A cooling medium 14 can be carried in the cooling hose. The line 10 has several electrical conductors 16. In the example from FIG. 2, twelve electrical conductors are shown by way of example. This is to be understood as purely exemplary and any plurality of electrical conductors 16 can be arranged around the cooling hose 12, for example from three inclusively to thirty electrical conductors 16 inclusively, in particular six to eighteen electrical conductors 16, or as a specific example fifteen electrical conductors 16. The cooling medium 14 is separated by the insulating sleeve of the respective cooling hose 12 from the electrical conductors 16 (for example, the copper/the copper conductors 16 or the aluminium/the aluminium conductors). Any type of cooling medium 14 can thus be used. This is advantageous compared with solutions which place electrical conductors, such as copper conductors, directly into a cooling liquid or have them enclosed by this. Here a risk exists if the cooling liquid is not completely/100% insulated. With the high voltages present, leakage currents can easily occur due to the cooling liquid, for example, and thus losses in the energy transmission.

The cooling hose 12 is formed at least virtually impenetrable for the cooling medium 14. The line 10 further has insulation 18. The insulation 18 encloses the cooling hose 12 and the electrical conductors 16.

The several electrical conductors 16 are arranged around the cooling hose 12 in the circumferential direction of the cooling hose 12. The several electrical conductors 16 each have a cross-sectional shape that differs from a (circular) round shape as depicted by way of example in FIG. 1.

The several electrical conductors 16 are formed by way of example as several electrical conductors 16 not insulated from one another.

The several electrical conductors 16 are in direct contact, for example, with the cooling hose 12. The ostensible distance between the conductors 16 and the cooling hose 12 in FIG. 2 serves only to illustrate the respective elements, i.e. the cooling hose 12 and the electrical conductors 16 and to make them distinguishable from one another. The same applies to the ostensible distance between the electrical conductors 16 and the insulation 18.

The several electrical conductors 16 are arranged as an example stranded with one another around the cooling hose 12 in FIG. 2. Alternatively, an unstranded arrangement around the cooling hose 12 is conceivable.

The several electrical conductors 16 are each formed as a stranded conductor. The respective stranded conductors of the several electrical conductors 16 are each formed by a plurality of single wires. The single wires can each be formed of copper or a copper alloy, in particular by enamel-insulated copper wires. The single wires are bunched with one another. The stranded conductors can accordingly each be formed as a bunched conductor (also termed a bundled strand). The single wires can be arranged in the stranded conductor arranged irregularly or unevenly relative to one another.

If such electrical conductors 16 formed as bunched conductors are stranded around the cooling hose 12, these open slightly and form a cross-sectional shape deviating from a circular cross-sectional shape.

The cross-sectional shape of the several electrical conductors 16 can be at least virtually trapezoidal in each case. In the example from FIG. 2, the electrical conductors 16 respectively have the shape of an isosceles trapezium in their cross section. Even if the electrical conductors 16 in FIG. 2 have an identical shape for the sake of simplicity, the exact shape of the electrical conductors 16 can differ from one another. For example, the trapeziums can be of different sizes and/or at least virtually isosceles and non-isosceles trapeziums can be combined with one another. The at least virtually trapezoidal electrical conductors 16 can also be described as conductor packets or conductor units.

The several electrical conductors each have an inner surface 16a pointing towards the cooling hose 12. The inner surface 16a of the several electrical conductors 16 is formed at least virtually concave in cross section in FIG. 2. The inner surface 16a of the electrical conductors 16 thus follows the shape of the exterior of the cooling hose 12. The radius of the concave shape of the inner surface 16a can thus correspond at least virtually to the radius of the cooling hose 12. Alternatively, the inner surfaces of the several electrical conductors 16 can be formed at least virtually even in cross section or have one or more even sections.

Furthermore, the several electrical conductors 16 each have an outer surface 16b pointing away from the cooling hose 12. The outer surface 16b of the several electrical conductors is formed at least virtually convex in cross section in FIG. 2. The outer surface 16b of the electrical conductors thus follows at least virtually the shape of the insulation 18. The radius of the convex shape of the outer surface 16b can thus correspond at least virtually to the radius of the insulation 18. Alternatively, the outer surface 16b of the several electrical conductors can be formed at least virtually even in cross section.

Due to the concave formation in cross section of the inner surface 16a of the electrical conductors 16, the electrical conductors 16 each rest with a contact surface AFT at least virtually on the cooling hose. With the electrical conductors 1600 with a round cross section from FIG. 1, a contact surface AFR of the electrical conductors rests on the cooling hose. The contact surface AFT is (significantly) larger than the contact surface AFR, for example at least twice as large. Thus due to the concave configuration of the inner surface 16a, a larger section of the electrical conductors 16 rests on the cooling hose 12 or has a direct heat-conducting connection, for example, to the cooling hose 12 than on electrical conductors 1600 with a convex inner surface like the round electrical conductors 1600. Expressed differently, a contact surface AFT of the electrical conductors 16 on the cooling hose 12 is (significantly) increased compared with a (circular) round configuration of the conductors 1600. For example, due to the concave inner surface 16a in cross section, the electrical conductors 16 can be placed more homogeneously onto the cooling hose 12 than (circular) round electrical conductors 1600. In particular, due to the concave formation in cross section of the inner surface 16a, a better thermal connection of the electrical conductors 16 to the cooling hose 12 is enabled. In this way, the efficiency of the cooling is improved. By improving the cooling efficiency, higher currents can be conducted through the line 10. Expressed differently, the current carrying capacity of the line 10 can be increased.

According to a variant not to be recognised in FIG. 2, a slight or minimal pressing-in, for example, of the single wires into the cooling hose 12 can be targetedly adapted or caused or achieved. Expressed differently, at least some or all of the single wires can (slightly) press in, at least in sections, into the cooling hose 12. Due to the (slight) pressing-in, the contact surface of single wire and cooling hose 12 is increased accordingly, whereby better heat transmission is enabled in turn. The pressing-in can be achieved by appropriate adjustment or adaptation of a stranding force in a stranding process of the electrical conductors 16 around the cooling hose 12.

For example, a line 10 from FIG. 2 with a cross section of 50 mm² can have at least virtually the same current carrying capacity as a line 1000 from FIG. 1 with (circular) round litz wires with a cross section of 70 mm².

In the following, it is assumed by way of example with regard to FIG. 3 that the electrical conductors 16 are copper conductors. Copper conductors 16 are therefore spoken of in part below with regard to FIG. 3.

In FIG. 3, a cross section of an exemplary embodiment of a charging cable 100 is shown. The charging cable 100 has a first line 10 from FIG. 2 and a second line 10 from FIG. 2. In FIG. 3, precisely a single first line 10 and precisely a single second line 10 are shown by way of example. Alternatively, also several first lines 10 and/or several second lines 10 can be provided. Furthermore, the charging cable 100 can optionally have alternating current lines. The alternating current lines can also be dispensed with, however. If no alternating current line is provided, the charging cable 100 is formed as a direct current charging cable. If, on the other hand, the two lines 10 and alternating current lines are provided, the charging cable 100 is formed as a combination charging cable for optional direct and alternating current charging. One or more signal lines can also be arranged in the charging cable 100. Furthermore, a protective earth conductor 40 is arranged in the charging cable 100. The charging cable 100 is enclosed by an outer jacket 50.

The charging cable 100 depicted schematically in FIG. 3 can be used as a charging cable for electric vehicles. For this application, the charging cable 100 is formed to enable a transmission output of, for example, up to 50 kW or up to 70 kW or up to 250 kW or up to 500 kW or up to 3.75 MW, in special cases up to 10 MW.

Purely as an example, the cooling hose 12 of the first line 10 is formed as a forward flow and the cooling hose 12 of the second line 10 is formed as a return flow for the cooling medium. Furthermore, the several electrical conductors 16 of the first line 10, for example, form a common positive direct current core by way of example and the several electrical conductors 16 of the second line 10 form by way of example a common negative direct current core. This is to be understood as purely exemplary and the invention is not restricted to this example.

Due to the special arrangement and formation of the electrical conductors 16, e.g. copper conductors, around the respective cooling hose 12, optimal or maximal heat dissipation is guaranteed. No additional insulation is present between the electrical conductors 16 (the copper/the copper conductors 16) and the direct contact with the respective cooling hose 12. Due to the direct contact, the plurality of electrical conductors 16, e.g. copper conductors, on the respective cooling hose 12 and the shape of the electrical conductors 16, optimal or maximal heat transmission exists.

With the described charging cable 100 according to the exemplary embodiment from FIG. 3, an improved cable is provided for charging electric vehicles. In the configuration from FIG. 1, contact points or short contact surfaces AFR, for example, can exist between the insulating sleeve of the cooling hose 1200 and the electrical conductors 1600. With the exemplary embodiments according to FIGS. 2 and 3, the electrical conductors 16 are more extensively in contact (via the contact surface AFT) with the cooling hose 12 and indirectly with the cooling medium 14. This means that an advantage of the exemplary embodiments from FIGS. 2 and 3 compared with the prior art from FIG. 1 is better heat transmission.

It is thus possible by means of the cooled line 10 from FIG. 2 and the cooled charging cable 100 from FIG. 3 to transmit a high power, for example from the charging station into the vehicle (and thus to the battery) or in the vehicle, despite smaller cross sections. The smaller cross sections would not normally be able to transmit this power because they would heat up too quickly due to the current load. This would lead to the maximally permitted conductor temperature according to EN 50620 or IEC 62893 being exceeded after a certain time. The service life of the lines could be impaired thereby.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

1. Line, in particular a high-voltage line for a vehicle or line for a charging cable, for example for electric vehicles, wherein the line comprises:
a cooling hose, in which a cooling medium can be carried; and
several electrical conductors, wherein the several electrical conductors are arranged around the cooling hose in the circumferential direction of the cooling hose and each have a cross-sectional shape that differs from a round, in particular a circular, shape.

2. Line according to claim 1, wherein the several electrical conductors are formed as several electrical conductors not insulated from one another.

3. Line according to claim 1, wherein the several electrical conductors are in direct contact with the cooling hose.

4. Line according to claim 1, wherein the several electrical conductors are arranged stranded with one another or unstranded around the cooling hose.

5. Line according to claim 1, wherein the several electrical conductors are each formed as a stranded conductor.

6. Line according to claim 5, wherein the respective stranded conductor of the several electrical conductors comprises a plurality of single wires or is formed by a plurality of single wires in each case, wherein the single wires are arranged irregularly or unevenly relative to one another.

7. Line according to claim 6, wherein one or more of the single wires press at least in sections into the cooling hose.

8. Line according to claim 1, wherein the cross-sectional shape of at least one of the several electrical conductors is at least virtually trapezoidal.

9. Line according to claim 1, wherein the several electrical conductors each have an inner surface pointing to the cooling hose, wherein the inner surface of at least one of the several electrical conductors is formed, at least in sections, at least virtually concave or at least virtually even in cross section.

10. Line according to claim 1, wherein the several electrical conductors each have an outer surface pointing away from the cooling hose, wherein the outer surface of at least one of the several electrical conductors is formed, at least in sections, at least virtually convex or at least virtually even in cross section.

11. Line according to claim 1, wherein the line further comprises insulation, wherein the insulation encloses the cooling hose and the several electrical conductors.

12. Charging cable, for example for electric vehicles, wherein the charging cable comprises at least a first line according to claim 1 and at least a second line according to claim 1.

13. Charging cable according to claim 12, wherein the cooling hose of the at least one first line is formed as a forward flow and the cooling hose of the at least one second line is formed as a return flow for the cooling medium or wherein alternatively the cooling hose of the at least one first line is formed as a return flow and the cooling hose of the at least one second line is formed as a forward flow for the cooling medium.

14. Charging cable according to claim 12, wherein the several electrical conductors of the at least one first line form a positive direct current core and the several electrical conductors of the at least one second line form a negative direct current core.

15. Charging cable according to claim 12, wherein two first lines and two second lines are provided, and wherein the several electrical conductors of the first lines form a common positive direct current core and the several electrical conductors of the second lines form a common negative direct current core.

16. A high-voltage line for a vehicle comprising:
a cooling hose for carrying a cooling medium; and
electrical conductors arranged circumferentially around the cooling hose, each electrical conductor having a non-round longitudinal cross-sectional shape.

17. The line according to claim 16, wherein the line is for a charging cable for an electrical vehicle.
